(19) United States
(12) Patent Application Publication
(10) Pub. No.: US 2002/0079170 A1
(43) Pub. Date: Jun. 27, 2002

(54) Fixed time fashion electrical brake protector device

(76) Inventors: Hsien-Chiarn Lee, Taipei (TW); Chen Chih Tung, Taoyuan Hsien (TW); Fu-Chang Hsu, Taoyuan (TW)

Correspondence Address: J.C. PATENTS INC., 4 VENTURE, SUITE250, IRVINE, CA, 92618, US

(21) Appl. No.: 09/749,523

(22) Filed: Dec. 27, 2000

(51) Int. Cl. F16D 66/00

(52) U.S. Cl. 188/1.11 E

(57) ABSTRACT

A fixed time fashion electrical brake arrester is provided with a fixed time fashion duty cycle limiter device that is mounted in the control loop of the fixed time fashion electrical brake arrester. The fixed time fashion duty cycle limiter device determines whether the duty cycle of the driving gate opening and the current of the driving motor should be limited. Hence, the current that is output when the motor is at rest does not exceed that of the maximum sustainable torque force so that the electrical arrester is prevented from being damaged.

### BACKGROUND OF THE INVENTION

1. Field of Invention

The invention relates to a protector device for electrical brakes. More particularly, the invention relates to a fixed time fashion protector device for electrical brakes.

2. Description of Related Art

Emphasis is placed on making brake devices where the mechanical structure is simple, to facilitate maintenance and adjustment, so that the cost can be reduced while the lifetime is extended. For the foregoing reasons, electrical control brake devices are gradually being used in modern brake products.

Conventionally, brake devices are divided into two categories: “Continuous fashion brake devices” and “Two stroke fashion brake devices”. The mechanism of a Continuous fashion brake device consists of passing from a state of complete release to a state of continuous braking. In turn, a Two stroke fashion brake device, well known as the ABS system, consists of the sequence of a time of braking and a time of releasing.

The purpose of an electrical control brake device is to use an electrical command to control the stroke and the force of the brakes. Conventionally, the electrical control brake device is comprised of an electrical arrester that is connected to a transmission bar whether directly or through the intermediary of springs or pneumatics. The transmission bar is in turn coupled to the brake members. The electrical arrester, that comprises a motor, receives a command stroke position that is transmitted, via the motor, to assign the stroke position of the transmission bar, that in turn guides the brake members stroke. Inasmuch as the brake members stroke is limited, when this limit is attained, even if the output of the arrester increases, the brake members stroke cannot increase further. Conventionally, the stroke position of the transmission bar feedback signal is compared to the command stroke position received by the electrical arrester. If there is an error between the command stroke position and the stroke position of the transmission bar, a current is generated to drive the motor so that it rotates in a direction such that the error should be reduced. The intensity of the driving current is dependent on the stroke position error and also on the torque force that is output by the motor. Specifically, when the motor is at rest while the current is maximal, the configuration thus attained is that of “the maximum static torque force”. Usually, the maximum static torque force cannot be sustained without inducing damages. Thus, the conventional arrester is designed in such a manner that it can sustain “a maximum sustainable static torque force” that is smaller than the “maximum static torque force”. The following equations are introduced to describe in further detail the arrester motor operation.

E=Rₐ·Iₐ+E_{b} (2-1)

E_{b}=K_{b}·ω (2-2)

T=Kₜ·Iₐ (2-3)

W=Iₐ²·Rₐ (2-4)

wherein,

E is the power voltage,

Rₐ is the armature resistance,

Iₐ is the armature current,

E_{b} is the anti-electromotive voltage,

K_{b} is the anti-electromotive constant,

ω is the motor rotation velocity,

T is the torque force,

Kₜ is the torque force constant, and

W is the heat dissipation puissance.

According to the equations (2-1) and (2-2), when the motor starts rotating or when it is prevented from rotating, the rotation velocity ω=0, and the anti-electromotive voltage E_{b}=K_{b}·ω=0, while the armature current Iₐ is maximum. According to equation (2-3), the torque force of the motor is consequently maximal. Equation (2-4) shows that the heat that is dissipated by the motor circuit is increased as the armature current Iₐ increases. If the configuration in which the current Iₐ is set to the maximum is maintained while the heat dissipation of the motor is not effective, it can result in a burning down of the motor circuit. Consequently, sustaining maximum armature current, which is the case when the maximum sustainable static torque force is attained, is the primary cause of motor damage. This critical issue is all the more frequently met when the stroke of the conventional transmission bar is small and, as a result, the command stroke is rapidly attained and may be unawares sustained.

Typically, an excessive command stroke of brake locking leads to the configuration of the maximum sustainable static torque force described above, which can cause damage to the brake members or damage to the arrester. A conventional solution is the mounting of a series of connection springs, a hydraulic or pneumatic device, or other buffer devices, to the transmission bar between the arrester and the brake members in order to extend the stroke of the transmission bar and absorb the stroke error. However, this solution makes the structure of the general brake device more complicated. Moreover, the stroke extension should not be excessive, which would negatively influence the reaction time of the brake device.

Reference will now be made in detail to the operating of the conventional electrical arrester of a brake device, with the help of FIG. 1 and FIG. 2. FIG. 1 shows a portion of the brake device while FIG. 2 shows a block diagram of the conventional electrical arrester. A conventional brake device comprises brake members (12, 22) that press rotating elements (10, 20). Through the friction forces that are thereby generated, the rotating elements (10, 20) are slowed down or stopped. However, once the brake members (12, 22) tightly press the rotating elements 10 and 20, the stroke 35 cannot increase further, which defines the limit of the stroke 35. Thus, if the electrical arrester 100 receives a command stroke that is greater than the limit of the stroke 35 of the brake members (12, 22), the stroke 35 cannot increase. Conventionally, the electrical arrester 100 comprises a driving gate duty cycle generator 102 in the control loop and, mounted thereafter, a motor 106. The motor 106 is connected to brake members 122 through a transmission bar 120. The driving gate duty cycle generator 102, according to the error between the command stroke that is received and the stroke that the transmission bar 120 outputs, delivers a gate opening duty cycle to the motor driving circuit 104 to drive the motor 106 and thus the stroke of the transmission bar 120. Theoretically, the conventional electrical arrester 100, according to the design of its structure and its circuitry, and the motor 208 capacitance, has a maximum sustainable static torque force threshold. However, the command stroke of brake locking usually exceeds the actual locking stroke. As a result, the arrester 100 or the motor 106 can be in the configuration wherein the maximal sustainable static torque force is attained for a period of time that can be substantially long. The armature current is consequently maximal and thus can induce damage to the arrester 100 and the motor 106. Therefore, it is necessary to frequently perform an accurate adjustment of the brake members 122 locking stroke. To attenuate this inconvenience, the conventional method, referred to above, mounts buffer devices on the transmission bar to absorb a part of the stroke error. However, this solution makes the structure more complex and is still limited.

### SUMMARY OF THE INVENTION

The invention relates to a fixed time fashion electrical brake protector device. More particularly, the invention relates to the use of a fixed time fashion duty cycle limiter device that is mounted in the control loop of the electrical brake arrester in the brake device. The electrical brake arrester comprises a driving gate duty cycle generator, a motor, a motor driving circuit and a transmission bar. The fixed time duty cycle limiter device is mounted between the driving gate duty cycle generator and the motor driving circuit of the electrical brake arrester, and continues the signals output by the driving gate duty cycle generator, so that the torque force, that is output by the motor and transmitted through the transmission bar to the brake members, can be controlled. If the duty cycle of the driving gate opening exceeds the duty cycle required for the maximum sustainable static torque force during an interval of time that is greater than a given interval of time, the fixed time duty cycle limiter device exerts a limitation to the duty cycle. The duty cycle is limited such that it is forced not to exceed the duty cycle that would have been required for the maximum sustainable static torque force.

Therefore, according to an advantage of the invention, the fixed time duty cycle limiter device of the invention can limit the duty cycle of the driving gate opening and the current output to the level of the duty cycle and the current of the maximum sustainable static torque force.

According to another advantage of the invention, even though the command stroke of the brake locking may substantially exceed the actual locking stroke, the electrical arrester is still protected inasmuch as the current output is prevented from exceeding the current of the maximum sustainable static torque force. Thus, the use of buffer devices is no longer necessary and the adjustment and maintenance of the entire brake device are thus simplified.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 shows a schematical view of conventional brake members;

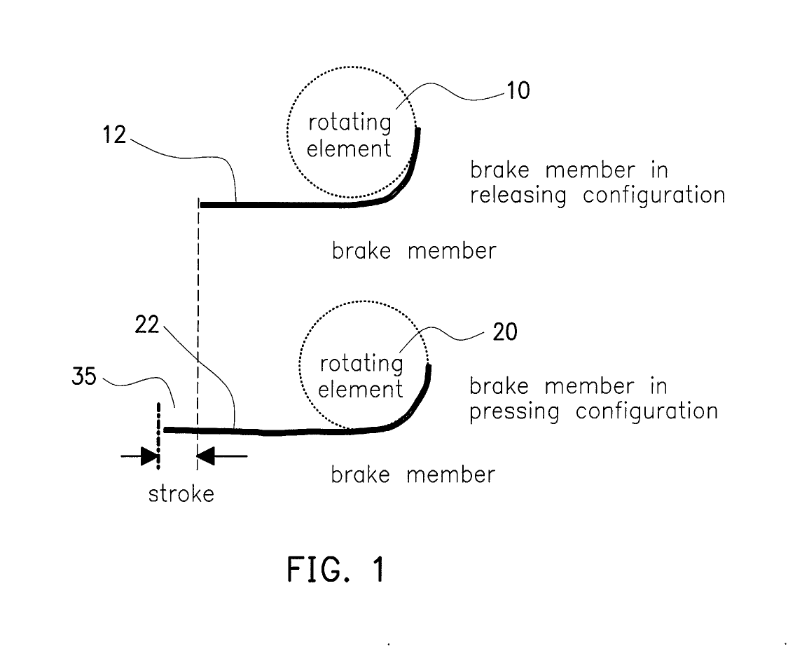

FIG. 2 shows a block diagram of a conventional electrical brake arrester;

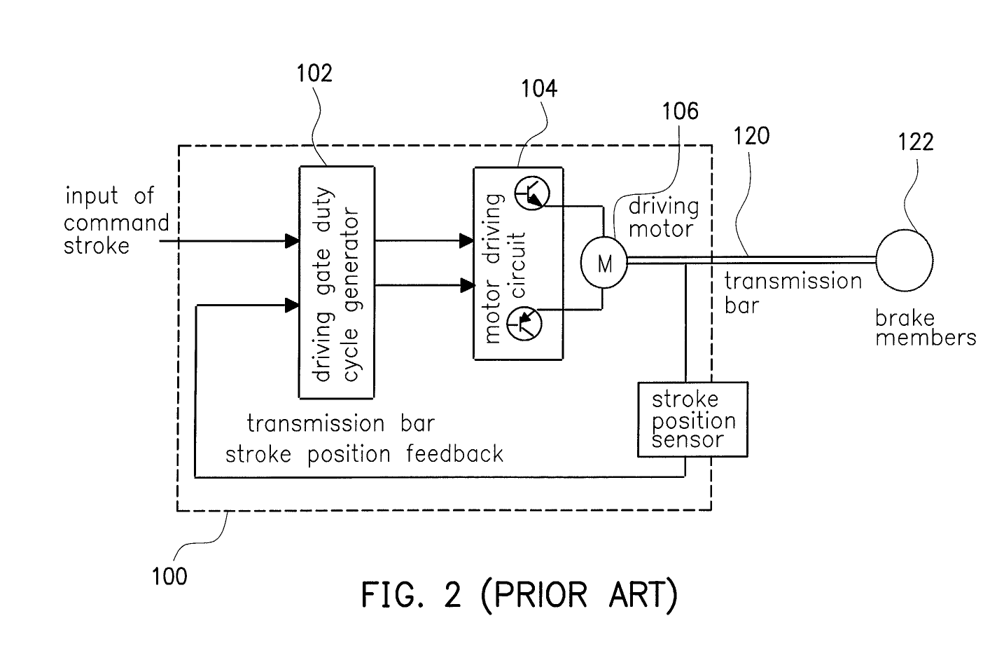

FIG. 3 shows a block diagram of the fixed time electrical arrester, according to an embodiment of the invention;

FIG. 4 shows a graph depicting the relationship between the stroke error and the output of the driving gate duty cycle generator, according to an embodiment of the invention; and

FIG. 5 shows an example of the output/time diagrams of the fixed time duty cycle limiter device, according to an embodiment of the invention.

### DESCRIPTION OF THE PREFERRED EMBODIMENTS

Hereinafter embodiments of the present invention will be explained concretely with reference to the accompanied drawings.

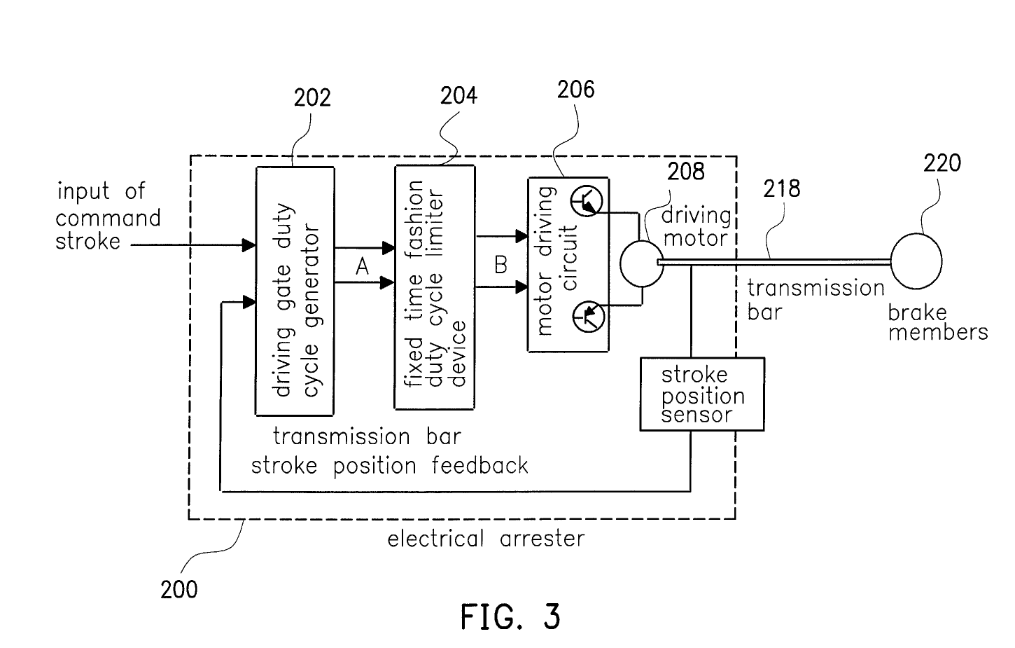

FIG. 3 shows a block diagram of a fixed time fashion arrester 200 according to a first embodiment of the invention. The fixed time fashion electrical arrester 200 comprises a driving gate duty cycle generator 202, a fixed time fashion duty cycle limiter device 204, a motor driving circuit 206, a motor 208, and a transmission bar 218. The motor 208 is connected to brake members 220 through the transmission bar 218. The fixed time fashion duty cycle limiter device 204 is mounted in the control loop of the fixed time fashion electrical arrester 200, between the driving gate duty cycle generator 202 and the motor driving circuit 206. According to the error between the command stroke that is received, and the feedback signal of the stroke that is output by the transmission bar 218 of the arrester, the driving gate duty cycle generator 202 commands both the direction of the motor 208 driving current and the duty cycle of the driving gate opening.

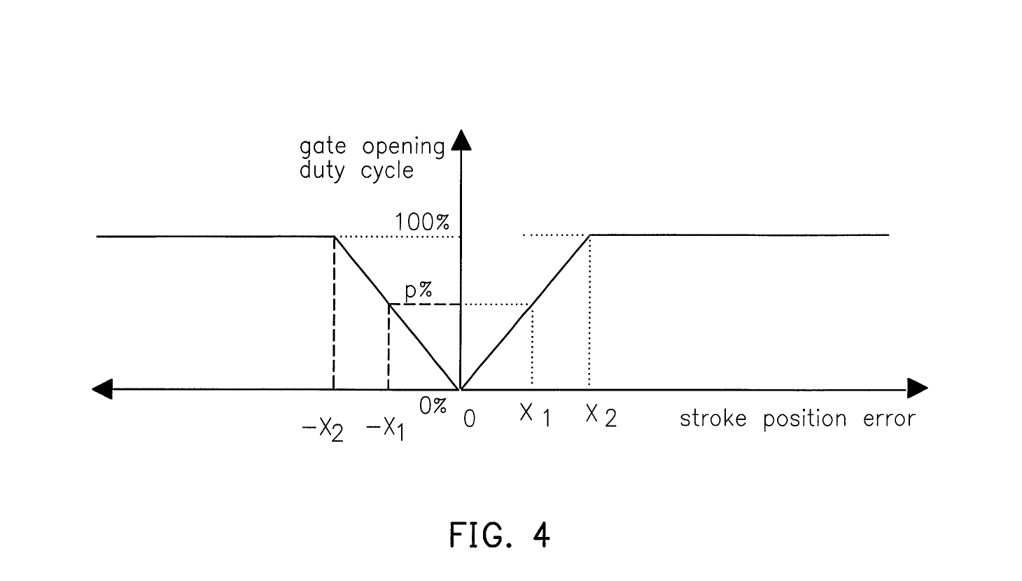

FIG. 4 is a graph showing the relationship between the output of the driving gate duty cycle generator 202 and the stroke position error. The abscissa axis represents the stroke position error while the ordinate axis represents the driving gate opening duty cycle. The duty cycle that is output varies from 0% to 100%. The driving gate opening duty cycle is shown as being proportional to the stroke position error. When the value of the stroke position error is zero, the value of the duty cycle that is output is zero. When the absolute value of the stroke position error is higher than a value X2, the value of the duty cycle that is output is 100%. If the error is negative, that means the direction of the motor 208 current has changed. If the motor 208 is at rest and the absolute value of the stroke position error is value X1, the fixed time fashion electric arrester 200 outputs a maximum sustainable static torque force while the duty cycle is set to a limit value p%. The fixed time fashion duty cycle limiter device 204 is directed to control the duty cycle of the driving gate opening that is output by the driving gate duty cycle generator 202. If the duty cycle of the driving gate opening that is sustained exceeds the duty cycle that would have been required to maintain the maximum sustainable static torque force, for instance the limit value p% as it is shown in FIG. 3, a time counter (not shown) of the fixed time fashion duty cycle limiter device 204 then starts counting the time while the excessive duty cycle is sustained. If the time counted attains, for instance, a threshold value tₛ, the fixed time fashion duty cycle limiter device 204 then actively limits the duty cycle of the driving gate opening and forces the duty cycle that is output not to exceed the limit value p%. If the duty cycle that is output by the driving gate duty cycle generator 202 recovers a value that is inferior to the limit value p% of the maximum sustainable static torque force, the fixed time fashion duty cycle limiter device 204 then stops the limitation action, and the time counter is reset. The threshold value tₛ is set according to the characteristics of the electrical arrester 200 and the short interval of time in which the current of maximum sustainable static torque force can be exceeded without causing damage.

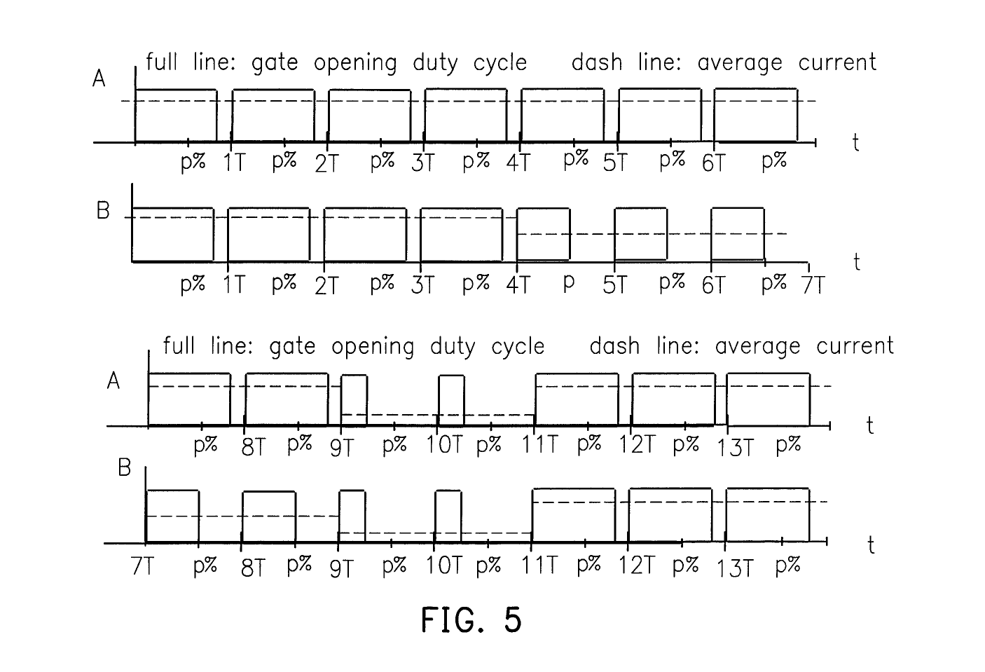

FIG. 5 shows an example of the output/time diagram, according to an embodiment of the invention. In the output/time diagram A, the full line shows the duty cycle that is output by a conventional driving gate duty cycle generator 202, while the dash line shows the average current that is output, wherein t is the symbol for the time and T is worth one full duty cycle. Similarly, the output/time diagram B shows the outputs of the duty cycle and the average current when the fixed time fashion duty cycle limiter device 204 of the invention is added.

In both diagrams A and B, the time duration value tₛ, in which the arrester 200 does not suffer damage, is defined, for instance, as being worth 4T. Between the time t=0 and the time t=9T, in the diagram A wherein there is no fixed time fashion duty cycle limiter device 204 of the invention, the duty cycle continuously exceeds the limit value p% of the maximum sustainable static torque force. In the diagram B wherein the fixed time fashion duty cycle limiter device 204 is added, the outputs are identical to those of the diagram A for the time t<4T. In contrast, for 4T<t<9T, the diagram B shows that the additional fixed time fashion duty cycle limiter device 204 actively limits the duty cycle output and the current output to the ratio p%. For the time t>9T, if, for instance, the command stroke decreases, the duty cycle output and the current output of the diagram A consequently also decreases. The outputs level of the diagram B identically also decreases. For the time t>11T, if the command stroke, for instance, increases again to exceed the limit value p%, the outputs consequently also increase. Because the time counter of the fixed time fashion duty cycle limiter device 204 has been reset, the limitation action thereof would be reactivated only after the time delay of tₛ=4T.

In conclusion, in accordance with the embodiment described above, the invention has the following advantages. According to a first advantage of the invention, the fixed time fashion duty cycle limiter device can limit the average current and the level of the duty cycle under the configuration of maximum sustained static torque force. Thereby, the duty cycle of the current gate opening is prevented from being set to the maximum level required under the condition of maximum sustained torque force, which can protect the arrester from damage.

According to another advantage of the invention, the fixed time fashion duty cycle limiter device can permit the command stroke position of the brake locking to substantially exceed the actual locking stroke without damaging the arrester. Thus, there is no need of any buffer devices mounted on the transmission bar. In operating conditions, the adjustment of the command stroke position such that it exceeds the actual stroke position is sufficient. Thus, the need for frequent, accurate corrections of the stroke is prevented, which makes the adjustment and maintenance operation easier.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A fixed time fashion electrical brake arrester that receives a command stroke signal and is coupled to brake members, suitable for a two-stroke fashion electrical brake device, the fixed time fashion electrical brake arrester comprising:
a transmission bar, which is coupled to the brake members, wherein the transmission bar outputs a transmission bar stroke feedback signal;
a driving gate duty cycle generator, which receives the command stroke signal and the transmission bar stroke feedback signal and outputs a first duty cycle and a first driving current level according to the error between the command stroke signal and the transmission bar stroke feedback signal, wherein the duty cycle is the duty cycle of a driving gate opening;
a fixed time fashion duty cycle limiter device, which receives respectively the first duty cycle, and the first driving current level, and outputs a second duty cycle and a second driving current level, wherein the second duty cycle and the second driving current level, which are limitation outputs of respectively the first duty cycle and the first driving current level, are determined through the evaluation of the first duty cycle and the first driving current level;
a driving motor, which is connected to the transmission bar and drives the transmission bar stroke; and
a motor driving circuit, which is connected to the fixed time fashion duty cycle limiter device, wherein the motor driving circuit receives the second duty cycle and the second driving current to control the duty cycle of the driving gate opening and the current level that supplies the driving motor.

2. The fixed time fashion electrical brake arrester of claim 1, wherein the second duty cycle and the second driving current are respectively inferior or equal to the first duty cycle and the first driving current.

3. A fixed time fashion electrical brake arrester that receives a command stroke signal and is coupled to brake members, suitable for a continuous fashion electrical brake device, the fixed time fashion electrical brake arrester comprising:
a transmission bar, which is coupled to the brake members, wherein the transmission bar outputs a transmission bar stroke feedback signal;
a driving gate duty cycle generator, which receives the command stroke signal and the transmission bar stroke feedback signal and delivers a first duty cycle and a first driving current level according to the error between the command stroke signal and the transmission bar stroke feedback signal, wherein the duty cycle is the duty cycle of a driving gate opening;
a fixed time fashion duty cycle limiter device, which receives respectively the first duty cycle and the first driving current level, and outputs a second duty cycle and a second driving current level, wherein the second duty cycle and the second driving current level, which are limitation outputs of respectively the first duty cycle and the first driving current level, are determined through the evaluation of the first duty cycle and the first driving current level;
a driving motor, which is connected to the transmission bar and drives the transmission bar stroke; and
a motor driving circuit, which is connected to the driving motor and the fixed time fashion duty cycle limiter device, wherein the motor driving circuit receives the second duty cycle and the second driving current level to control the duty cycle of the driving gate opening and the current level that supplies the driving motor.

4. The fixed time fashion electrical brake arrester of claim 3, wherein the second duty cycle and the second driving current are respectively inferior or equal to the first duty cycle and the first driving current.
